(19) United States
(12) Patent Application Publication
(10) Pub. No.: US 2016/0034931 A1
(43) Pub. Date: Feb. 4, 2016

(54) SYSTEMS AND METHODS FOR GENERATING A LOCATION SPECIFIC INDEX OF ECONOMIC ACTIVITY

(71) Applicant: APPLIED PREDICTIVE TECHNOLOGIES, INC., Arlington, VA (US)

(72) Inventors: Mark D'Agostino, Washington, DC (US); Alex Svistunov, Arlington, VA (US); David Nedzel, Half Moon Bay, CA (US); Scott Ings, Washington, DC (US)

(73) Assignee: APPLIED PREDICTIVE TECHNOLOGIES, INC., Arlington, VA (US)

(21) Appl. No.: 14/448,501

(22) Filed: Jul. 31, 2014

(51) Int. Cl. G06Q 30/02

(52) U.S. Cl. CPC G06Q 30/0205

(57) ABSTRACT

The systems and methods described herein can index the economic activity in a trade area of a location by identifying a set of data concerning the economic activity of a plurality of locations and storing it with the associated geographic position of each of the locations. A geographic trade area is then determined for each of the locations, using either a pre-set area defined as a radius from the location or through input by a user. The database is queried to identify all of the locations within the trade area of the subject location. The economic activity associated with the locations is aggregated and compared across time periods to create the index of the economic activity within the subject location's trade area. The economic activity from these locations may also be weighted by any number of factors, including distance from the subject location, and type of retailer.

### FIELD OF THE INVENTION

The present teaching relates to methods, systems, and programming for determining business conditions within the trade area of a location.

### BACKGROUND

Retailers and suppliers of consumer products (as well as financial institutions that invest in or lend to those businesses) need information on the economic conditions under which their business networks are operating. They need to know whether their business networks are outperforming the overall economic environment and, therefore, that their business initiatives are succeeding, or whether they are underperforming and need to introduce new initiatives, change pricing strategies, or revise marketing plans. A retail chain growing its sales at 3% per year should draw very different conclusions concerning that growth depending on whether overall consumer spending is down 2% during the year or is up 5% during the year.

In addition, operators of business networks such as retailers and banks need to determine the performance of individual locations within the business networks. Currently, retailers are able to determine how individual locations are performing relative to their own histories, i.e., “same store” metrics. In this way, a retailer could determine that a particular store in the retailer's chain had sales that increased by 2% year over year. Each location within the network can be compared to the network as a whole as well; an individual store growing at 5% might be doing well compared to overall 3% growth by the network as a whole.

Accordingly, the need for information on economic conditions extends down to the local economic environment and the store level. While a retailer may understand that its overall chain is performing well, it may not know whether individual stores that are lagging its overall sales trend are the result of poor store management, local competition, or localized economic difficulty. A retailer would draw different conclusions for a store with a 2% increase in sales year over year depending on whether all retailers in the area were experiencing a 2% increase in sales or 0% or negative sales growth.

A retailer with information on the economic activity within the trade areas around its business network locations would be able to make better decisions concerning the effectiveness of operations in those locations. For example, if a location was not otherwise a poor performing location in the context of the business network as a whole, but consistently trailed the economic activity of its surrounding geography, the business network operator could identify that location as in need of an improvement in management, in need of renovation, etc., to increase its effectiveness. Similarly, if a location performed poorly relative to the business network as a whole, but consistently outperformed the economic activity of the surrounding geography, management at that location might be identified as worthy of a promotion, or the practices of that location could be studied to determine how other locations could outperform their local economies.

Additionally, having information about the economic activity within the trade areas around individual trade locations would allow business network operators to conduct more accurate controlled tests of business initiatives across a network. In recent years, businesses have realized the importance of testing out proposed changes in certain test locations before rolling them out across the network. To get a clear understanding of the impact of the changes on the test sites, it becomes critical to compare the test sites with control sites where the same changes have not been made. These control sites should be as similar as possible to the test sites in order to lower the measurement error.

In identifying control sites, businesses now use factors such as location size, overall level of sales, demographics, the seasonality of sales, long term sales trends and other factors to identify control locations. However, the creation of a control set might be improved if the local economic activity surround a store is a variable that is controlled for in the test. A set of locations that match a test location on seasonality of sales and long term sales trends may be an imperfect match when local economic conditions are taken into account; adding the local economic environment would improve the control group and thereby create a more accurate test measurement.

Currently, there are broad measures of economic activity available nationally, such as the Gross Domestic Product (“GDP”) reports and the retail sales reports issued by the Department of Commerce (through the Bureau of Economic Analysis and the Census Bureau, respectively). These broad economic measures are often adequate to determine demand and economic activity on a broad national basis. Moreover, they generally have a lagged reporting time of one month or more, and may be less useful to retailers who have their business networks concentrated in particular regions.

There are also regional measures of economic activity, including the Beige Books prepared by the Federal Reserve, yearly state and regional GDP reports by the Bureau of Economic Analysis, and reports put together by state level economics agencies. In the case of the Federal Reserve's Beige Books, the reports are anecdotal rather than data-driven. The state and regional-level GDP reports are produced infrequently, often on an annual basis.

The national, regional and state reporting of economic activities is still too broad to be useful in analyzing the performance of individual locations within a business network. While the Census Bureau does supply some economic activity data at a local economic level, and some firms provide county-level economic data, that local economic data is supplied on a very infrequent basis. The infrequency of the data makes it unable to support real-time analysis of a location's performance.

In addition, the local areas for which reports are available may not match the trade areas from which a business location draws its customers. For example, a toy store may draw customers from portions of multiple census block groups, making the economic data from the entirety of those block groups only partially relevant. As such, even if the local economic data were provided on a more timely basis, it would not provide an adequate basis for determining the economic activity within a business location's trade network.

As a result of the foregoing, there is a need for updated, location-specific data on the economic conditions in the trade area of that location that takes into account the economic activity associated with other businesses within the trade area.

### SUMMARY

The embodiments disclosed herein are methods and systems that attempt to provide the unmet needs by determining and indexing the amount of economic activity in a business network location's trade area by calculating the economic activities associated with locations in different business networks whose own trade areas overlap with the trade area of the subject location and determining the total amount of economic activity within the overlapped areas.

In one embodiment, a computer-implemented method comprises receiving, by a first computer, a transmission from a second computer including a message identifying a subject location and requesting an index value of economic activity for the subject location; storing, by the first computer, in a database economic activity data for each of a plurality of locations; storing, by the first computer, in the database a geographic position of each of the plurality of locations; determining, by the first computer, a geographic trade area of the subject location with reference to the geographic position of the subject location stored in the database; determining, by the first computer, which of the locations within the plurality of locations are within the geographic trade area of the subject location; deriving, by the first computer, an aggregate of the economic activity for the locations within the geographic trade area of the subject location for a first period of time and a second period of time; calculating, by the first computer, the index value of economic activity within the geographic trade area of the subject location based on a change in the economic activity between the first period of time and the second period of time; and transmitting, by the first computer, the index value to the second computer requesting the index value for the subject location.

In another embodiment, a computer program product embodied on a non-transient computer readable medium, wherein the computer program product has instructions that when executed by a processor perform the method comprising receiving, by a processor, a transmission from a computer including a message identifying a subject location and requesting an index value of economic activity for the subject location; storing, by the processor, in a database economic activity data for each of a plurality of locations; storing, by the processor, in the database a geographic position of each of the plurality of locations; determining, by the processor, a geographic trade area of a subject location with reference to the geographic position of the subject location stored in the database; determining, by the processor, which of the locations within the plurality of locations are within the geographic trade area of the subject location; deriving, by the processor, an aggregate of the economic activity for all of the locations within the geographic trade area of the subject location for a first period of time and a second period of time; calculating, by the processor, the index value of economic activity within the geographic trade area of the subject location based on a change in the aggregate of the economic activity between the first period of time and the second period of time; and transmitting, by the processor, the index value to the computer requesting the index value for the subject location.

In yet another embodiment, a computer-implemented method comprises receiving, by a first computer, a transmission from a second computer including a message identifying a subject location and requesting an index value of economic activity for the subject location; storing, by the first computer, in a database economic activity data for each of a plurality of locations; storing, by the first computer, in the database a geographic position of each of the plurality of locations; determining, by the first computer, a distance between the subject location and each of the plurality of locations based on the geographic position stored in the database; deriving, by the first computer, an aggregate of the economic activity surrounding the subject location by summing economic activity of the plurality of locations as weighted by the distance for a first period of time and a second period of time; calculating, by the first computer, the index value of economic activity within the geographic trade area of the subject location based on a change in the aggregate of the economic activity between the first period of time and the second period of time; and transmitting, by the first computer, the index value to the second computer requesting the index value for the subject location.

In one embodiment, a computer program product embodied on a non-transient computer readable medium, wherein the computer program product has instructions that when executed by a processor perform the method comprising receiving, by the processor, a transmission from a computer including a message identifying a subject location and requesting economic activity for the subject location; storing, by the processor, information comprising economic activity of each a plurality of locations; storing, by the processor, information comprising a geographic position of each of the plurality of locations; determining, by the processor, geographic trade areas of each of the plurality of locations with reference to the geographic position of each of the plurality of locations; determining, by the processor, an overlapped area between a geographic trade area of a selected location and geographic trade areas of other locations in the plurality of locations; determining, by the processor, economic activity within each overlapped area during a time period in relation to the total economic activity of each of the other locations; and aggregating, by the processor, the economic activity during the time period from each overlapped trade area into a single measure of economic activity within the geographic trade area of the selected location during the time period; and transmitting, by the processor, a message including the economic activity to the computer requesting the economic activity for the subject location.

In another embodiment, a computer-implemented method comprises receiving, by a first computer, a transmission from a second computer including a message identifying a subject location and requesting economic activity for the subject location; storing, by the first computer, information comprising economic activity of each a plurality of locations; storing, by the first computer, information comprising a geographic position of each of the plurality of locations; determining, by the first computer, geographic trade areas of each of the plurality of locations with reference to the geographic position of each of the plurality of locations; determining, by the first computer, an overlapped area between a geographic trade area of a selected location and geographic trade areas of other locations in the plurality of locations; determining, by the first computer, economic activity within each overlapped area during a time period in relation to the total economic activity of each of the other locations; and aggregating, by the first computer, the economic activity during the time period from each overlapped trade area into a single measure of economic activity within the geographic trade area of the selected location during the time period; and transmitting, by the first computer, a message including the economic activity to the second computer requesting the economic activity for the subject location.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows a system overview according to an exemplary embodiment.

FIG. 2 shows a method for identifying locations in a trade area according to an exemplary embodiment.

FIG. 3 shows economic activity for locations in a trade area according to an exemplary embodiment.

FIG. 4 shows locations in a trade area according to an exemplary embodiment.

FIG. 5 shows a flow chart of a method according to an exemplary embodiment.

FIG. 6 shows a flow chart of a method according to an exemplary embodiment.

FIG. 7 shows a method for identifying locations in a trade area according to an alternative embodiment.

FIG. 8 shows a flow chart of a method according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

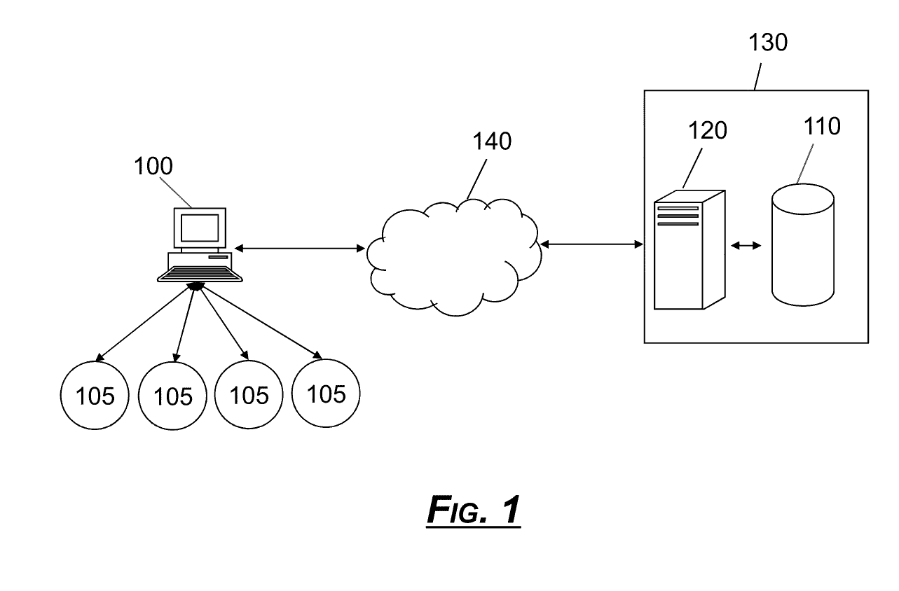

Referring to FIG. 1, an exemplary system diagram is shown. A client has a business network comprised of various entities 105, which may be business locations, stores, sites, students, accounts, customers, products, services, regions, patients, or other types of entities. Although the exemplary embodiment often refers to the entity as a “store” or “location,” it is intended that any type of entity can be used. The business network can comprise one or more stores or locations (e.g., as a sole proprietorship or a franchised store). The entities 105 may provide similar products and/or services to customers. In some embodiments, the entities 105 may be geographically dispersed.

A client computer 100 can represent one or more computers of the client, who may manage the various entities 105 or track data regarding the entities 105. In one example, for a consumer business, the client can be an organization headquarters or a marketing division for one or more entities 105 (e.g., a grocery store chain that determines which products and/or services each retailer location should provide). In some embodiments, each entity 105 can have its own client and computer 100. In other embodiment, a client and the computer 100 can be used for multiple entities 105. One or more users (not shown) may operate the computer 100. The computer 100 can be a desktop computer, workstation, laptop, personal data assistant, tablet computer, mobile phone, or any other similar computing system operated by a user. The computer 100 may use its processor to execute browser software stored in memory that enables a user to request, receive, and render information from a network 140.

The network 140 may be a shared, public, or private network and may encompass a wide area or a local area. The network 140 may be implemented through any suitable combination of wired and/or wireless communication networks. For example, network 140 may be implemented through a wide area network (WAN), local area network (LAN), an intranet, and/or the Internet. Further, network 140 may represent multiple networks, such as a wireless carrier network connected to the Internet.

The computer 100 transmits or otherwise provides historical data regarding entities 105 to a host entity 130. In this exemplary configuration, the host entity has a server 120 is coupled to the database 110, though the server 120 and the database 110 can be combined into a single device or each comprise multiple devices. The server 120 can be a computer system such as a desktop computer, workstation, or any other similar server side computing system that performs one or more service-side processes. The server 120 can have an interface unit for communicating information to and from the client's computer 100 over the network 140. In some embodiments, the server 120 may communicate with another server, such as a web server, that can more directly communicate over the network 140. The server 120 can use its processor to execute a computer program stored in memory that can access and analyze the data stored in the database 110.

The database 110 can comprise one or more memory devices that store data and/or executable software that is used by the server 120 to perform processes consistent with certain aspects described herein. The database 110 may be located external to server 120 and accessible through the network 140 or other network, such as a dedicated back-end communication path. In one embodiment, the database 110 can be located at the client or another location, such as with server 120. The database 110 can be populated with records about the client's historical data for various locations, sales, promotions, pricing, personnel, and the like. The client computer 100 can communicate with the server 120 to request analysis and view results.

In one embodiment, the client uses computer 100 to communicate over the Internet 140 with the host entity's server 120. The computer 100 may use a thin client, such as a web browser, which accesses a website hosted by the host entity 130. The client may be prompted to enter a username and password into the web browser on the computer 100. The client can be authenticated to access data and perform analysis of that data. Alternatively, the client may request that another entity, such as the host entity 130 perform the analysis of their business initiative.

The database 110 stores historical data for a client. The data can be gathered over time, or the data can be gathered by a client and transmitted to a host entity for analysis of the data once all of the data has been collected.

The server 120 uses various inputs, some of which may be entered by the client, an administrator of the server 120, or other party. The inputs may also be set as default settings on the server 120 and may be customized by the client or administrator. In the exemplary embodiment, an entity that enters an input or maintains the system having a particular input is referred to as a user, though the user may include the client or an administrator.

For a particular location, the server 120 can generate a measure of economic activity corresponding to an area within a trade areas of all locations with a business network of that particular location. The server 120 receives data on economic activity (e.g., sales, numbers of transactions, or customer traffic) from locations within a plurality of business networks, and the server 120 associates this data with the geography of those locations (e.g., by using precise geocoding). The data and the associations are stored in the database 110. The server 120 can provide an index of economic activity for any location within a business network by defining a trade area around that location and then calculating the overall change in economic activity within that trade area over a time period (e.g., a week, month, quarter, year).

The server 120 can automatically calculate the index value on a periodic basis, or the server 120 can automatically calculate the index value upon receiving a transmission from the computer 100 requesting the index value. The computer 100 may transmit a request for an index value to the server 120, where the request includes information identifying a subject location, and in response, the server 120 automatically calculates the index value and transmits it back to the computer 100 for display on a user interface of the computer 100. In an alternative embodiment, the server 120 can calculate an index value on a periodic basis (e.g., daily, weekly, monthly) and transmit the index value to the computer 100 for display on a user interface of the computer 100. The server 120 can transmit the periodic calculation of the index value to a computer 100 upon each request or upon receiving a request to automatically transmit the index value on a periodic basis. The index value may be transmitted via email, SMS, other messaging format, may be presented on a web page that is rendered in a browser on the computer 100, or otherwise presented for display in an application or user interface on computer 100. The server 120 can also transmit index values for a plurality of subject locations to computer 100 in a single transmission or a plurality of transmissions. Although only one computer 100 is shown, it is intended that there are a plurality of computers that request and/or receive an index value, and each index value is calculated for a specific subject location. As a result, an index value for a first subject location requested by a first computer will be different than an index value for a second subject location requested by a second computer.

Although the exemplary embodiments recite the use of economic activity for stores or other retail locations, it is intended that the systems and methods can be applied to any asset that has economic activity that changes from a first period to a second period, such as housing prices, available jobs, hours worked, inventory movement, etc.

The index value generated by the system could have many uses. For example, the index value could be used to analyzing the location's relative performance to its surrounding trade area. The index value generated can then be used to compare the location's relevant economic activity metric against the surrounding geographic area. In addition, the index could be used as a store attribute when conducting a controlled test of business initiatives; test stores could have a control group that features stores in locations with similar economic activity index or with similar relative performance to the surrounding economic activity.

In one embodiment, a computer-implemented method of determining and indexing the amount of economic activity in a trade area of a location within a business network includes identifying a set of data concerning the economic activity of a plurality of locations within a plurality of business networks and storing that data along with the associated geographic position of each of the locations in a database. A geographic trade area is then determined for each of the locations in the plurality of business networks, using either a pre-set area defined as a radius in miles (or other unit of measurement) from the location or through input by a user of a computer software interface connecting to the database. The database is then queried to identify all of the locations within the plurality of business networks within the trade area of the business locations. The economic activity associated with the locations is then retrieved from the database and aggregated, either individually or collectively, and compared across time periods to create the index of the economic activity within the trade area of the business locations. Alternatively, the economic activity of each location can be indexed individually and an index for the subject location can be derived from the collective indices of all of the locations within the subject location's trade area. The economic activity from the locations within the trade area may also be weighted by any number of factors, including distance from the subject location, type of retailer, store volume, or number of stores per brand.

In another embodiment, a computer-implemented system of determining and indexing the amount of economic activity in the trade area of a location within a business network comprises a database storing a set of data concerning the economic activity of a plurality of locations within a plurality of business networks, which is associated with a geographic position of each of the locations. A computer, which is communicatively coupled to the database, then determines a trade area for each of the locations in the plurality of business networks, using either a pre-set area defined as a radius in miles (or other unit of measurement) from the location or through input by a user of a computer software interface connecting to the database. The computer then queries the database to determine the overlap among the trade areas among the plurality of locations for each individual location. The computer calculates the overlap between trade areas, and the economic activity for each location is assigned proportionally based on the amount of the overlap, whether it is complete (i.e., 100%) or partial (e.g., 50%). The computer then calculates an index of the economic activity in the overlapped areas within a subject location's trade area and then compared across time periods to create a time series of the index of the economic activity within the subject location's trade area.

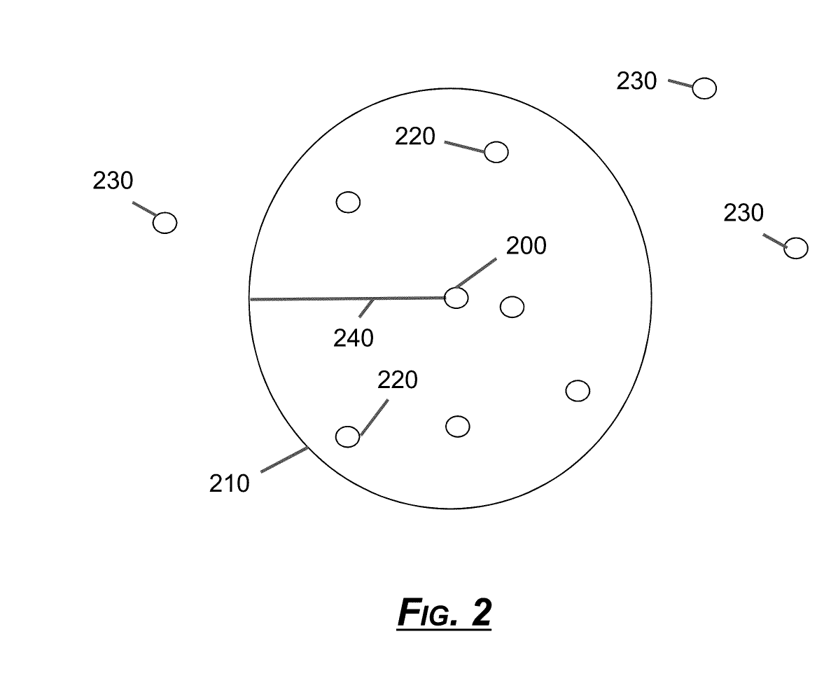

Referring to FIG. 2, an exemplary method for identifying locations within a trade area is shown. A database stores a record of economic activity for each location along with a geographic position of that particular location. A subject store 200 is identified. This subject store can be identified by a selection by a computer of a user or based upon a query of the database using desired criteria. In order to create an index for location 200, a trade area 210 is calculated for the location 200 based on a radius 240 or user input. For example, a user can input a radius 240 into a computer, and the inputted radius 240 may be used to calculate the radius 240 of the trade area 210. For example, the radius can be 1 mile, 10 miles, 50 miles, or 100 miles. The database has a record of the geographic location (e.g., longitude and latitude) of location 200 and can calculate which locations are included in a trade area of a radius 240 extending about that that location 200. Alternatively, rather than basing the radius on a subject location, the radius can be based upon a geographic landmark, such as centroid of a zip code.

Locations are included in the trade area 210 if they are within the trade area 210 radius 240. The identification of which locations are within the trade area 210 is determined by using their geographic coordinates, which are stored in the database. In this exemplary embodiment, locations 220 are within the trade area 210, and locations 230 are outside of the trade area 210. The economic activity associated with the locations 220 within the trade area 210 is then retrieved from the database across designated time periods (e.g., one day, one week, one month, one quarter, one year).

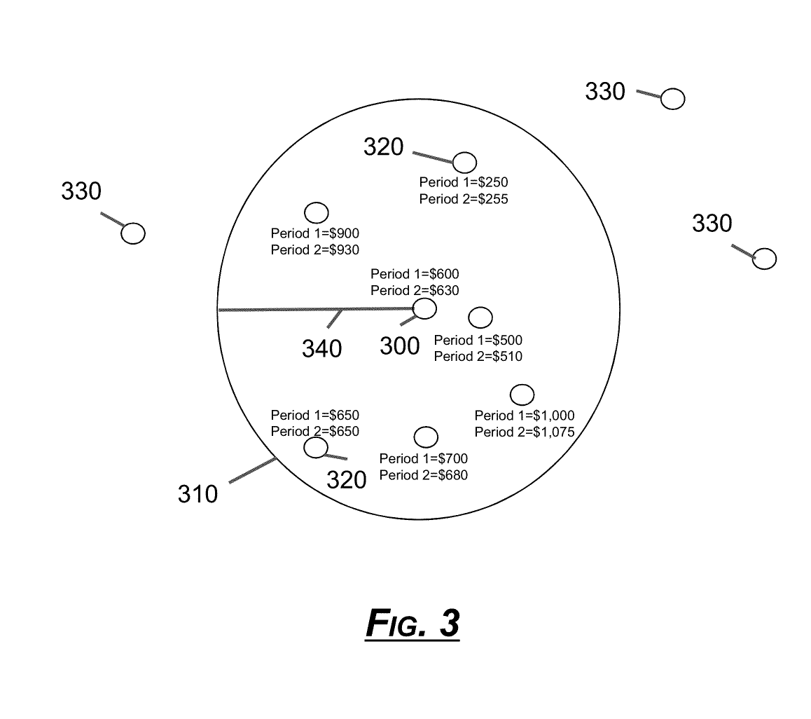

Referring to FIG. 3, a database stores records of historic economic activity for each of the locations. Economic activity can include total sales, number of transactions, customer traffic, or other business-related metrics. The economic activity can be compared for two time periods, such as the latest data versus a previous day, week, month, quarter, or year. Each time period can be a predetermined amount of time, and the database stores the data for historical economic activity, so the server can retrieve data for only the requested periods in order to perform a comparison.

In this exemplary embodiment, the index is calculated using the locations 320 within a trade area 310 defined by a radius 340 about location 300. Locations 330 are excluded from the index calculation. In addition, any locations that are the same brand or banner as the subject location 300 may be optionally excluded from the calculation as well. In this example, the historic economic activity may be for sales. For each location 320, a sales amount for each location in a first period is determined. The amount for each location 320 is aggregated for a total amount for the first period, but the amount for the subject location 300 is excluded. In this example, the total amount for the first period is $4000. This total value can also be divided by a baseline total value for all locations in the trade area. For example, this could be the average sales value for these locations in the most recent full calendar year. If the average total weekly sales amounts for these locations in the last year is $3200, the index value for this period is 1.25 (4000 divided by 3200). These baseline values seek to normalize the index and mask the absolute magnitude of the sales amount included in the index calculation. The index is thus provided as a unit-less measure just as other common indices (e.g., the S&P 500). The values for a second economic period also are aggregated for these locations 320, excluding the subject location 300. In this example, the total amount for the second period is $4100. This value would also be divided by the same baseline value of $3200 to arrive at an index value of 1.28. These normalized index values can be provided as a time series for a specified frequency (every day, every week, every month, etc.) or for specific requested time periods.

In another exemplary embodiment, the index can be based on a normalization of the economic activity for each of the locations within the trade area. An index value is created for each of the locations 320 within trade area 310 defined by radius 340 about location 300, which is then used to create an index for location 300. For each location 320, the economic activity of the first period is normalized by using a measure of central tendency, such as a mean (average), geometric mean, median, etc., to create a baseline value. The values for a second economic period are compared to this baseline to create an index for each location 320 during the second period. In FIG. 3, the Period 1 values for each location 320 (clockwise from top, $250, $500, $1,000, $700, $650, and $900) could represent averages of weekly sales across Period 1. Individual index values of (clockwise from top) 1.02, 1.02, 1.075, 0.971, 1, and 1.033 could then be created from the Period 2 weekly sales values. An index then can be created for location 300 for the second period by combining the indices of each location 320 in the second periods, such as by averaging the indices to 1.0996. Such combination can occur by use of measures of central tendency such as means or medians, or by use of weighting mechanism that accounts for distance from location 300 or type of business network, etc.

The server can also compare the index value in the first period to the index value in the second period. In this example, the second period had a 2.5% increase in the index (economic activity) from the first period.

The index value can then be compared to a change in the economic activity of the subject location 300. The subject location 300 was $630 in the first period and $600 in the second period, which is a 5% increase. The server can determine the relative performance of the subject location 300 to the performance of the locations 320 in the trade area 310. In this example, the subject location 300 outperformed the economic activity of the locations 320 in the trade area 310 by 2.5 percentage points.

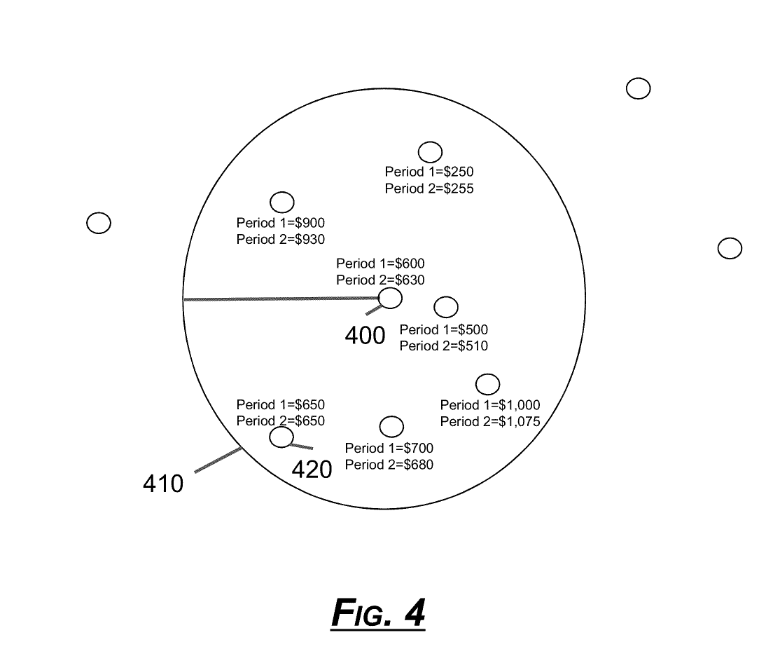

The economic activity associated with each location 320 can be weighted, such as by applying more weight to those location closer to the subject location in the trade area. For example, referring to FIG. 4, location 420 is the most distant location from the subject location 400 in the trade area 410. Location 420 had a sales total of $650 in the first period and $650 in the second period. The sales total of location 420 can be discounted (e.g., by 25%) to reflect the fact that the economic activity more distant from the center of the trade area. In one embodiment, weighting can be applied by type of location (e.g., those locations in a same category have a higher weighting). In another embodiment, a higher weighting can be applied to those locations having a similar square footage as the subject location. As a result, a big box store would receive a higher weighting when determining an index value for another big box store.

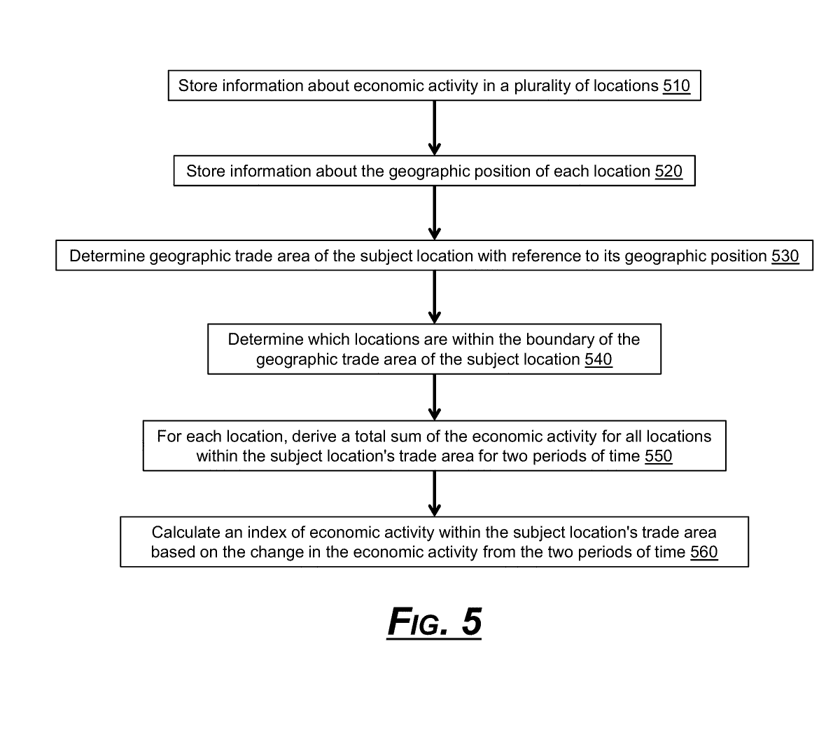

Referring to FIG. 5, an exemplary process for determining business conditions within a trade area of a subject location is shown. This process may be embodied by instructions stored on a computer-readable medium that are executed by a processor, for example, server 120 and database 110 shown in FIG. 1, though the functionality may be performed by a single computer. In step 510, a database stores information comprising the amount of economic activity of a plurality of locations within a plurality of business networks.

In step 520, the database stores information about the geographic location of each of the plurality of locations. The geographic location may be based upon a longitude and latitude of each location.

In step 530, the server determines the geographic trade areas of the plurality of locations with reference to their geographic positions. In one embodiment, the trade area can be determined by a radius extending from the subject location. In another embodiment, the trade area can be defined by the business network of the subject location. For example, the trade area can be based upon a geographic area that does not overlap with another location of that business network. In another example, the trade area can be based upon a radius inputted into a computer of a representative of the business network (e.g., computer 100). In another embodiment, the trade area can be defined by an amount of time it takes for a consumer to drive to the location from the subject location or other starting point.

In step 540, the server determines which of the locations are within the boundary of a geographic trade area for a subject location. Only the locations within the boundary of the trade area of the subject location will be used for generating an index value.

In step 550, for each of the locations within the boundary of the geographic trade area for the subject location, the server derives from the database an aggregate of the economic activity for all of the locations within the subject location's trade area for two periods of time. In one embodiment, the aggregate of economic activity may be based upon categories. For example, the locations can be divided by business networks into retail categories, e.g., clothing, restaurants, supermarkets. In another example, the system may have various categories, such as retail and restaurants, only retail, and only restaurants. The system may also have sub-categories, such as an apparel sub-category or sporting goods sub-category for retail. The index can be based upon only the retail category of the subject location.

In step 560, the server calculates an index of economic activity within the subject location's trade area based on the change in the amount of economic activity from the two periods of time. In one embodiment, the economic activity of each location in the trade area can be weighted based upon its distance from the subject location. The server can transmit the index value to a computer associated with an entity requesting the index value. Alternatively, the server can post the index value to a website or store it in the database for later retrieval upon receipt of a query or other request.

In an alternative embodiment, an index may be calculated without determining a geographic trade area for the subject location, but rather based upon weighting the economic activity associated with each of the plurality of locations based on the distance from the subject location.

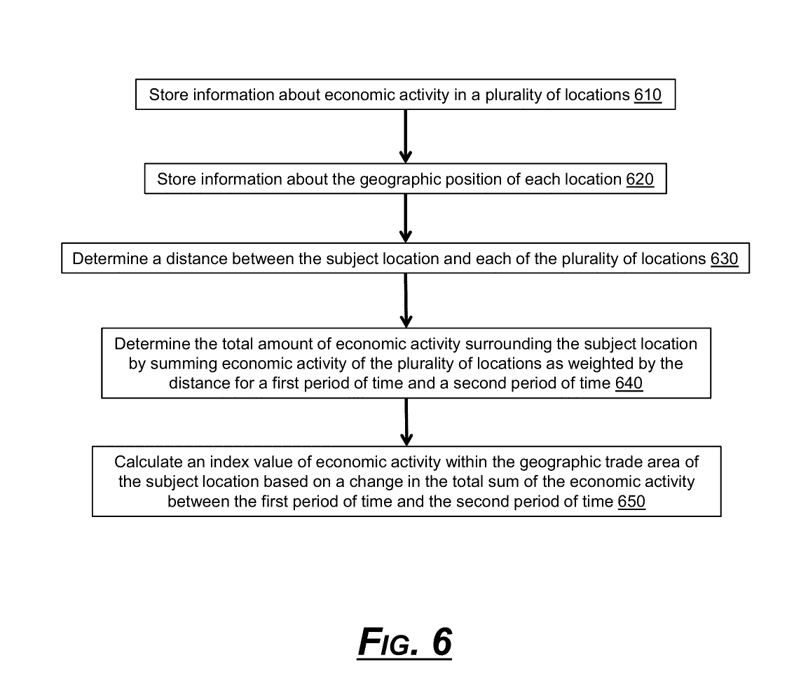

Referring to FIG. 6, an exemplary process for determining the business conditions within a trade area of a subject location is shown. This process may be embodied by instructions stored on a computer-readable medium that are executed by a processor, for example, server 120 and database 110 shown in FIG. 1, though the functionality may be performed by a single computer. In step 610, a database stores information comprising the amount of economic activity of a plurality of locations within a plurality of business networks.

In step 620, the database stores information about the geographic location of each of the plurality of locations. The geographic location may be based upon a longitude and latitude of each location. The longitude and latitude can be based upon the actual geographic location of the business, or it can be based upon a geographic landmark, such as the center of a zip code where the business is based.

In step 630, the server retrieves geographic location information from the database and determines a distance between the subject location and each of the plurality of locations. The distance can be calculated based upon a difference between the longitude and latitude of the subject location and each of the plurality of locations. The server may receive instructions to include particular locations (e.g., all locations within a zip code or county) and/or may determine that a distance of a location is beyond a threshold and should not be included in the index value calculation (e.g., exclude from the data set all locations with a distance beyond a threshold of 10 miles).

In step 640, the server determines an amount of economic activity surrounding the subject location by summing economic activity of the plurality of locations as weighted by the distance for a first period of time and a second period of time. For example, a smaller distance can have a greater weight than a larger distance. The server will determine the economic activity for each location on a first date and a second date and apply a weight to those values based on the distance of the location from the subject location. Then the server will aggregate the economic activity for each location. An area surrounding the subject location can be an area defined by a radius from the subject location, a geographically-defined area such as a zip code, a distance based upon driving time, or any other mechanism for determining an area around a subject location.

In step 650, the server calculates an index value of economic activity within the geographic trade area of the subject location based on a change in the economic activity between the first period of time and the second period of time. The server will determine the difference between the first date and the second date for the aggregate of the economic activity to determine this change. The difference in the aggregate of economic activity can be converted to an index value, e.g., by using a percentage change. The server can transmit the index value to a computer associated with an entity requesting the index value. Alternatively, the server can post the index value to a website or store it in the database for later retrieval upon receipt of a query or other request.

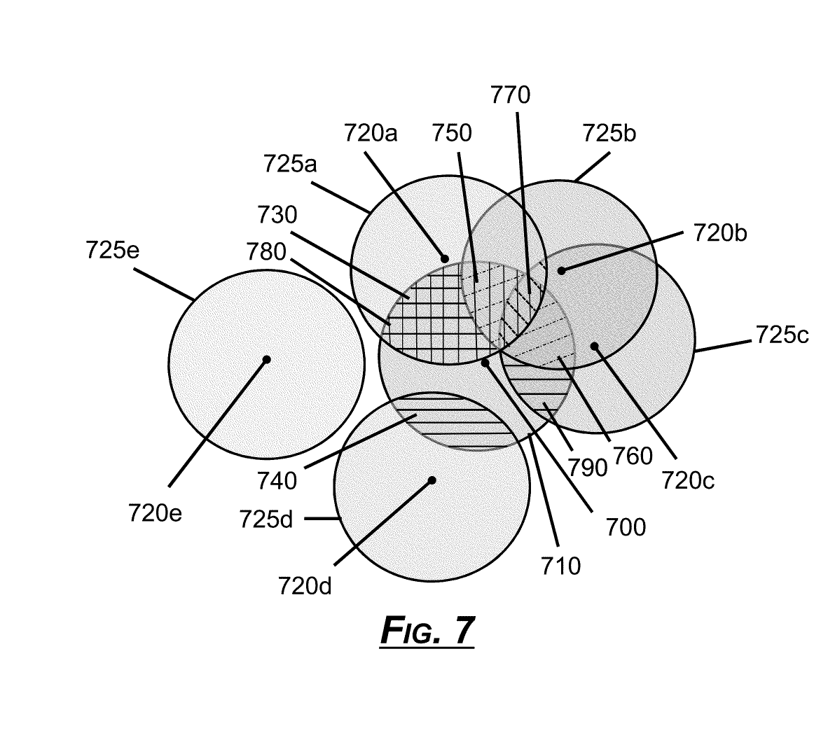

In an alternative embodiment, an index may be based upon overlapping trade areas. As shown in FIG. 7, a subject location 700 has a trade area 710. The trade area 710 may be calculated by a radius of a predetermined distance about the subject location 700.

For the subject location 700, an index is created by assigning a portion of the overall sales of index locations 720 to a trade area overlap between the subject location 700 and the Index locations 720. For example, index location 720a has a trade area 725a, which may be calculated by a radius of a predetermined distance about the index location 720a. This radius may be the same value or a different value from the radius used to define trade area 710. The overall sales of index location 720a are allocated between sales not within the trade area 710 of the subject location 700 and those in the portion 730 (shown with vertical lines) of the trade area 710 that overlaps with trade area 725a. The portion of the sales allocated to the overlap 730 with the trade area 710 of the subject location 700, as defined by percentage of the area of the overlap to the overall trade area 725a of the index location 720a, is added to the total measure of economic activity for the index. In one example, a first overlapping area has an overlap of 40%. The overlapping area has sales of $1000 in a first period and $2000 in a second period. For this overlapping area, the economic activity for the first period will be $400 and the economic activity for the second period will be $800. The process is repeated for each of the index locations 720b, 720c, 720d and the overlap between their trade areas 725b, 725c, 725d and the trade area 710 of the subject location 700. Note that for a location 720e with no overlap between its trade area 725e and the trade area 710 of the subject location 700, no sales data is used.

As shown in FIG. 7, for a portion of the trade area 710 for the subject location 700, there is no overlap with another trade area and, therefore, no index data. For other portions of trade area 710, there may be areas with overlap 740 for one location 720d (and overlap 780 with location 720a, overlap 790 with location 720c), overlap 750 with two locations 720a, 720b (and overlap 760 with location 720b, 720c), and overlap 770 with three locations 720a, 620b, 720c. The remaining areas have no overlap between trades areas 720a, 720b, 720c, 720d, 720e and the subject trade area 710.

The total sales of each of the overlapped areas 730, 740, 750, 760, 770, 780, 790 is aggregated to a total level of sales during the period measured. The aggregate level of sales during the period can then be compared to the aggregate level of sales during prior periods to yield an index value. Thus, for example, if total sales allocated to the overlapped areas during a first period, which would be the baseline period, are $1.0 million and increase to $1.2 million in a second period, the index value would be set at 1.2. The sales may also be indexed on an individual store basis to normalize the effects of movements of sales at larger stores relative to smaller stores.

The operators of the business network that includes the subject location can then compare the sales in the subject location during a second period with reference to the economic activity in the subject location's trade area. If, using the index value described above, the index for the subject location is 1.2 for the second period compared to the first period, and the subject location's sales increased by more than 20%, the operators of the business network would know that the subject location performed better than suggested by the overall economic activity in the subject location's trade area. If the subject location's sales increased by less than 20%, the operators would know that the subject location performed worse than suggested by the overall economic activity in the subject location's trade area.

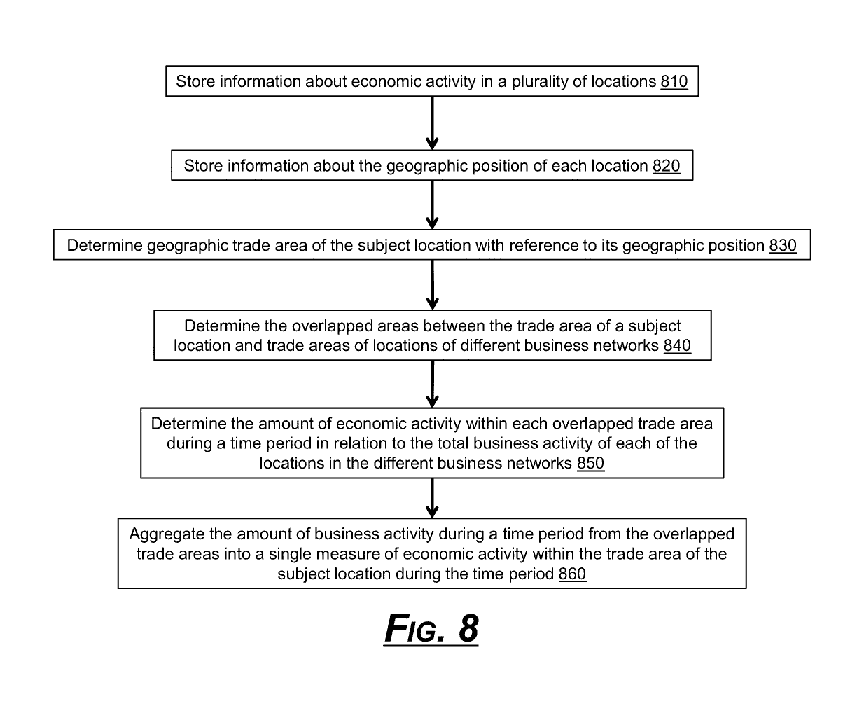

Referring to FIG. 8, an exemplary process for determining the business conditions within a trade area of a subject location is shown. This process may be embodied by instructions stored on a computer-readable medium that are executed by a processor, for example, server 120 and database 110 shown in FIG. 1, though the functionality may be performed by a single computer. In step 810, a database stores information comprising the amount of economic activity of a plurality of locations within a plurality of business networks.

In step 820, the database stores information about the geographic location of each of the plurality of locations. The geographic location may be based upon a longitude and latitude of each location.

In step 830, the server determines the geographic trade areas of the plurality of locations with reference to their geographic positions. In one embodiment, the trade area can be determined by a radius extending from the subject location. In another embodiment, the trade area can be defined by the business network of the subject location. For example, the trade area can be based upon a geographic area that does not overlap with another location of that business network. In another example, the trade area can be based upon a radius inputted into a computer of a representative of the business network (e.g., computer 100). In another embodiment, the trade area can be defined by an amount of time it takes for a consumer to drive to the location from the subject location or other starting point.

In step 840, the server determines the overlapped areas between the trade area of the subject location of a business network and the trade areas of locations of other business networks. In one alternative, the server can determine the overlapped areas between the trade area of the subject location and trade areas of all other locations, even if those other locations are in the same business network.

In step 850, the server determines the amount of economic activity within each overlapped trade area during a time period in relation to the total economic activity of each of the locations. In one embodiment, the determination of the amount of economic activity within the overlapped trade area is made using a distribution of the economic activity that varies over the distance from the location.

In step 860, the server aggregates the amount of economic activity during a time period from the overlapped trade areas into a single measure of economic activity within the trade area of the selected location during the time period. In one embodiment, the aggregation economic activity may be based upon categories. For example, the locations can be divided by business networks into retail categories, e.g., clothing, restaurants, supermarkets. The index can be based upon only the retail category of the subject location. The server can transmit the index value to a computer associated with an entity requesting the index value. Alternatively, the server can post the index value to a website or store it in the database for later retrieval upon receipt of a query or other request.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “processing” or “computing” or “calculating” or “determining” or “displaying” or “identifying” or “detecting” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g., computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that there are numerous alternative components and embodiments that may be substituted for or included in the particular examples described herein and such additions or substitutions still fall within the scope of the invention.

What is claimed is:

1. A computer-implemented method comprising:
receiving, by a first computer, a transmission from a second computer including a message identifying a subject location and requesting an index value of economic activity for the subject location;
storing, by the first computer, in a database economic activity data for each of a plurality of locations;
storing, by the first computer, in the database a geographic position of each of the plurality of locations;
determining, by the first computer, a geographic trade area of the subject location with reference to the geographic position of the subject location stored in the database;
determining, by the first computer, which of the locations within the plurality of locations are within the geographic trade area of the subject location;
deriving, by the first computer, an aggregate of the economic activity for the locations within the geographic trade area of the subject location for a first period of time and a second period of time;
calculating, by the first computer, the index value of economic activity within the geographic trade area of the subject location based on a change in the economic activity between the first period of time and the second period of time; and
transmitting, by the first computer, the index value to the second computer requesting the index value for the subject location.

2. The method according to claim 1, wherein a subset of the plurality of locations are in a business network.

3. The method according to claim 1, wherein the economic activity data comprises total sales.

4. The method according to claim 1, wherein the economic activity data comprises number of transactions.

5. The method according to claim 1, wherein the economic activity data comprises customer traffic.

6. The method according to claim 1, wherein deriving the aggregate of economic activity comprises:
determining, by the computer, which locations are associated with a particular retail category; and
determining, by the computer, the economic activity of the locations associated with the particular retail category in the first period and the second period.

7. The method according to claim 1, wherein the geographic trade area of the subject location is defined by the business network of the subject location.

8. The method according to claim 1, wherein the locations associated with the business network of the subject location are excluded from the aggregate of economic activity.

9. The method according to claim 1, wherein the geographic trade area of the subject location is defined based upon a selected radius from the subject location.

10. The method according to claim 1, wherein the geographic trade area of the subject location is defined by a selected amount of time to drive to that location.

11. The method according to claim 1, wherein deriving the aggregate of economic activity comprises determining, by the computer, economic activity for each location within the geographic trade area using a distribution of the economic activity that varies over a distance from the subject location.

12. The method according to claim 1, wherein deriving the aggregate of economic activity comprises determining, by the first computer, the total economic activity for all locations within the geographic trade area in the first period by normalizing the economic activity for all locations during the period to create a baseline index, and then comparing the economic activity for all locations within the geographic trade area during the second period to the first period baseline index to create an index for the subject location in the second period.

13. The method according to claim 1, wherein deriving the aggregate of economic activity comprises determining, by the first computer, the economic activity for each location within the geographic trade area in the first period by normalizing the economic activity for such location during the period to create a baseline index for each of the locations, and then comparing the economic activity for each location within the geographic trade area during the second period to the first period baseline index to create a second period index for each of the locations, and then combining the individual second period indices for each of the locations into a combined second period index for the subject location.

14. A computer program product embodied on a non-transient computer readable medium, wherein the computer program product has instructions that when executed by a processor perform the method comprising:
receiving, by a processor, a transmission from a computer including a message identifying a subject location and requesting an index value of economic activity for the subject location;
storing, by the processor, in a database economic activity data for each of a plurality of locations;
storing, by the processor, in the database a geographic position of each of the plurality of locations;
determining, by the processor, a geographic trade area of a subject location with reference to the geographic position of the subject location stored in the database;
determining, by the processor, which of the locations within the plurality of locations are within the geographic trade area of the subject location;
deriving, by the processor, an aggregate of the economic activity for all of the locations within the geographic trade area of the subject location for a first period of time and a second period of time;
calculating, by the processor, the index value of economic activity within the geographic trade area of the subject location based on a change in the aggregate of the economic activity between the first period of time and the second period of time; and
transmitting, by the processor, the index value to the computer requesting the index value for the subject location.

15. The method according to claim 14, wherein a subset of the plurality of locations are in a business network.

16. The method according to claim 14, wherein the economic activity data comprises total sales.

17. The method according to claim 14, wherein the economic activity data comprises number of transactions.

18. The method according to claim 14, wherein the economic activity data comprises customer traffic.

19. The method according to claim 14, wherein deriving the aggregate comprises:
determining, by the processor, which locations are associated with a particular retail category; and
determining, by the processor, the economic activity of the locations associated with the particular retail category in the first period and the second period.

20. The method according to claim 14, wherein the geographic trade area of the subject location is defined by the business network of the subject location.

21. The method according to claim 14, wherein the geographic trade area of the subject location is defined based upon a selected radius from the subject location.

22. The method according to claim 14, wherein the geographic trade area of the subject location is defined by a selected amount of time to drive to that location.

23. The method according to claim 14, wherein deriving the aggregate of economic activity comprises determining economic activity for each location within the geographic trade area using a distribution of the economic activity that varies over a distance from the subject location.

24. The method according to claim 14, wherein deriving the aggregate of economic activity comprises determining, by the processor, the total economic activity for all locations within the geographic trade area in the first period by normalizing the economic activity for all locations during the period to create a baseline index, and then comparing the economic activity for all locations within the geographic trade area during the second period to the first period baseline index to create an index for the subject location in the second period.

25. The method according to claim 14, wherein deriving the aggregate of economic activity comprises determining, by the processor, the economic activity for each location within the geographic trade area in the first period by normalizing the economic activity for such location during the period to create a baseline index for each of the locations, and then comparing the economic activity for each location within the geographic trade area during the second period to the first period baseline index to create a second period index for each of the locations, and then combining the individual second period indices for each of the locations into a combined second period index for the subject location.

26. A computer-implemented method comprising:
receiving, by a first computer, a transmission from a second computer including a message identifying a subject location and requesting an index value of economic activity for the subject location;
storing, by the first computer, in a database economic activity data for each of a plurality of locations;
storing, by the first computer, in the database a geographic position of each of the plurality of locations;
determining, by the first computer, a distance between the subject location and each of the plurality of locations based on the geographic position stored in the database;
deriving, by the first computer, an aggregate of the economic activity surrounding the subject location by summing economic activity of the plurality of locations as weighted by the distance for a first period of time and a second period of time;
calculating, by the first computer, the index value of economic activity within the geographic trade area of the subject location based on a change in the aggregate of the economic activity between the first period of time and the second period of time; and
transmitting, by the first computer, the index value to the second computer requesting the index value for the subject location.

27. The method according to claim 26, wherein a subset of the plurality of locations are in a business network.

28. The method according to claim 26, wherein the economic activity data comprises total sales.

29. The method according to claim 26, wherein the economic activity data comprises number of transactions.

30. The method according to claim 26, wherein the economic activity data comprises customer traffic.

31. The method according to claim 26, wherein deriving the aggregate of economic activity comprises:
determining, by the computer, which locations are associated with a particular retail category; and
determining, by the computer, the economic activity of the locations associated with the particular retail category in the first period and the second period.

32. The method according to claim 26, wherein the locations associated with the subject location's business network are excluded from the aggregate of economic activity.

33. The method according to claim 26, wherein any of the plurality of locations whose total economic activity as weighted by distance from the subject fall below a set threshold are excluded from the aggregate of economic activity.

34. The method according to claim 26, wherein deriving the aggregate of economic activity comprises determining, by the first computer, the total economic activity for all locations in the first period by normalizing the economic activity for all locations as weighted by distance from the subject location during the period to create a baseline index, and then comparing the economic activity for all locations as weighted by distance from the subject location during the second period to the first period baseline index to create a second period index for the subject location.

35. The method according to claim 26, wherein deriving the aggregate of economic activity comprises determining, by the first computer, the economic activity for each location in the first period by normalizing the economic activity for such location during the period to create a baseline index for each of the locations, and then comparing the economic activity for each location during the second period to the first period baseline index to create a second period index for each of the locations, and then combining the individual second period indices for each of the locations as weighted by distance from the subject location into a combined second period index for the subject location.

36. A computer program product embodied on a non-transient computer readable medium, wherein the computer program product has instructions that when executed by a processor perform the method comprising:
receiving, by the processor, a transmission from a computer including a message identifying a subject location and requesting economic activity for the subject location;
storing, by the processor, information comprising economic activity of each a plurality of locations;
storing, by the processor, information comprising a geographic position of each of the plurality of locations;
determining, by the processor, geographic trade areas of each of the plurality of locations with reference to the geographic position of each of the plurality of locations;
determining, by the processor, an overlapped area between a geographic trade area of a selected location and geographic trade areas of other locations in the plurality of locations;
determining, by the processor, economic activity within each overlapped area during a time period in relation to the total economic activity of each of the other locations; and
aggregating, by the processor, the economic activity during the time period from each overlapped trade area into a single measure of economic activity within the geographic trade area of the selected location during the time period; and
transmitting, by the processor, a message including the economic activity to the computer requesting the economic activity for the subject location.

37. The method according to claim 36, wherein the economic activity data comprises total sales.

38. The method according to claim 36, wherein the economic activity data comprises number of transactions.

39. The method according to claim 36, wherein the economic activity data comprises customer traffic.

40. The method according to claim 36, wherein aggregating economic activity comprises:
determining, by the processor, which locations are associated with a particular retail category; and
determining, by the processor, the economic activity of the overlapped area for the locations associated with the particular retail category.

41. The method according to claim 36, wherein the geographic trade area of the subject location is defined by the business network of the subject location.

42. The method according to claim 36, wherein the geographic trade area of the subject location is defined based upon a selected radius from the subject location.

43. The method according to claim 36, wherein the geographic trade area of the subject location is defined by a selected amount of time to drive to that location.

44. The method according to claim 36, wherein deriving the aggregate of economic activity comprises determining, by the processor, the total economic activity for all locations within the geographic trade area in the first period by normalizing the economic activity for all locations during the period to create a baseline index, and then comparing the economic activity for all locations within the geographic trade area during the second period to the first period baseline index to create an index for the subject location in the second period.

45. The method according to claim 36, wherein deriving the aggregate of economic activity comprises determining, by the processor, the economic activity for each location within the geographic trade area in the first period by normalizing the economic activity for such location during the period to create a baseline index for each of the locations, and then comparing the economic activity for each location within the geographic trade area during the second period to the first period baseline index to create a second period index for each of the locations, and then combining the individual second period indices for each of the locations into a combined second period index for the subject location.

46. A computer-implemented method comprising:
receiving, by a first computer, a transmission from a second computer including a message identifying a subject location and requesting economic activity for the subject location;
storing, by the first computer, information comprising economic activity of each a plurality of locations;
storing, by the first computer, information comprising a geographic position of each of the plurality of locations;
determining, by the first computer, geographic trade areas of each of the plurality of locations with reference to the geographic position of each of the plurality of locations;
determining, by the first computer, an overlapped area between a geographic trade area of a selected location and geographic trade areas of other locations in the plurality of locations;
determining, by the first computer, economic activity within each overlapped area during a time period in relation to the total economic activity of each of the other locations; and
aggregating, by the first computer, the economic activity during the time period from each overlapped trade area into a single measure of economic activity within the geographic trade area of the selected location during the time period; and
transmitting, by the first computer, a message including the economic activity to the second computer requesting the economic activity for the subject location.

47. The method according to claim 46, wherein the economic activity data comprises total sales.

48. The method according to claim 46, wherein the economic activity data comprises number of transactions.

49. The method according to claim 46, wherein the economic activity data comprises customer traffic.

50. The method according to claim 46, wherein aggregating economic activity comprises:
determining, by the computer, which locations are associated with a particular retail category; and
determining, by the computer, the economic activity of the overlapped area for the locations associated with the particular retail category.

51. The method according to claim 46, wherein the geographic trade area of the subject location is defined by the business network of the subject location.

52. The method according to claim 46, wherein the geographic trade area of the subject location is defined based upon a selected radius from the subject location.

53. The method according to claim 46, wherein the geographic trade area of the subject location is defined by a selected amount of time to drive to that location.

54. The method according to claim 46, wherein deriving the aggregate of economic activity comprises determining, by the first computer, the total economic activity for all locations within the geographic trade area in the first period by normalizing the economic activity for all locations during the period to create a baseline index, and then comparing the economic activity for all locations within the geographic trade area during the second period to the first period baseline index to create an index for the subject location in the second period.

55. The method according to claim 46, wherein deriving the aggregate of economic activity comprises determining, by the first computer, the economic activity for each location within the geographic trade area in the first period by normalizing the economic activity for such location during the period to create a baseline index for each of the locations, and then comparing the economic activity for each location within the geographic trade area during the second period to the first period baseline index to create a second period index for each of the locations, and then combining the individual second period indices for each of the locations into a combined second period index for the subject location.
